(19) United States
(12) Patent Application Publication
(10) Pub. No.: US 2011/0062053 A1
(43) Pub. Date: Mar. 17, 2011

(54) Chimerized Wafer Boat for Use in Semiconductor Chip Processing and Related Methods

(75) Inventors: Francis Vo, Union City, CA (US); Paul Henderson, Philadelphia, PA (US)

(73) Assignee: Greene Tweed of Delaware, Inc., Wilmington, DE (US)

(21) Appl. No.: 12/835,399

(22) Filed: Jul. 13, 2010

Related U.S. Application Data
(60) Provisional application No. 61/224,997, filed on Jul. 13, 2009.

(51) Int. Cl. B65D 85/00; B31B 3/00

(52) U.S. Cl. 206/722; 493/52

(57) ABSTRACT

The invention provides a wafer boat for housing a semiconductor or a solar wafer that includes at least one wafer support member containing at least one slot capable of receiving at least a portion of a peripheral edge of a wafer, wherein in the wafer support member comprises silicon carbide; and at least one structural member for conveying the wafer boat into and out of a processing device connected to the wafer support member , wherein the structural member is comprised of a ceramic material that is not silicon carbide. Also included are methods of manufacturing a wafer boat having increased durability and/or chip resistance.

### CROSS REFERENCE TO RELATED APPLICATIONS

This application claims the benefit under 35 U.S.C. 119(e) of U.S. Provisional Patent Application No. 61/224,997, filed Jul. 13, 2009, the contents of which are incorporated herein by reference.

### BACKGROUND OF THE INVENTION

Semiconductor device fabrication is the process used to create chips, the integrated circuits that are present in everyday electrical and electronic devices. It is a multiple-step sequence of photographic and chemical processing steps during which electronic circuits are gradually created on a wafer made of pure semiconducting material. Silicon is the most commonly used semiconductor material today, along with various compound semiconductors.

A typical wafer is made out of extremely pure silicon that is grown into mono-crystalline cylindrical ingots (boules) up to 300 mm (slightly less than 12 inches) in diameter using the Czochralski process. These ingots are then sliced into wafers about 0.75 mm thick and polished to obtain a very regular and flat surface. Once the wafers are prepared, many process steps are necessary to produce the desired semiconductor integrated circuit.

In general, the various processing steps fall into four general categories: deposition, removal, patterning, and modification of electrical properties. Each category of process may involve numerous steps and sub-processes, each of which may require transport of the wafers from one device to another.

To reduce and/or eliminate damage to wafers during the process steps and during transport to and from the various devices, the wafers are carried on carrier devices or “wafer boats”. The wafer boats are necessarily subjected to the same corrosive chemicals and/or high temperatures under which the wafers are processed. In addition, after wafer processing, the wafer boats are themselves subjected to chemical cleaning processes to remove any particulates and/or other impurities to avoid contamination of any subsequent wafer batches.

Formats of various wafer boats are well know in the art and may differ depending on the size and nature of the wafer (e.g., diameters ranging from 100 mm to 500 mm and thicknesses of about 0.15 to about 1.5 mm) and/or the structures of the processing equipment into which the wafers are placed. For example, horizontal wafer boats are used in processes that involve horizontal oxidation furnaces, and vertical wafer boats in processes that involve vertical furnaces.

In conventional practice, a ceramic wafer boat is fabricated from a single material. In part this had been considered necessary to eliminate the possibility of a high movement of tolerances under the extreme temperature and chemical conditions, which would result in damage to the boat and/or, more significantly, cause damage to the wafers that are carried on the boat.

The cost effectiveness of given wafer boat depends on the number of times it can be used, cleaned and re-used without damage; thus, it is important that the materials selected are durable (i.e., resistant to damage from high heat and chemical resistance to the chemicals used in cleaning processes). Consequently, the most often used materials are quartz and silicon carbide. Quartz boats are advantageous because of their lower per unit cost. However, they are easily damaged and require vigilant monitoring for damage and frequent replacement. Silicon carbide boats are resistant to damage but are also significantly more expensive.

Thus, there remains a need in the art for wafer boats that are durable and less expensive on a cost per unit basis.

### BRIEF SUMMARY OF THE INVENTION

The invention provides a wafer boat for housing a semiconductor or a solar wafer that includes at least one wafer support member containing at least one slot capable of receiving at least a portion of a peripheral edge of a wafer, wherein in the wafer support member comprises silicon carbide; and at least one structural member for conveying the wafer boat into and out of a processing device connected to the wafer support member , wherein the structural member is comprised of a ceramic material that is not silicon carbide. Also included are methods of manufacturing a wafer boat having increased durability and/or chip resistance.

### DESCRIPTION OF THE SEVERAL VIEWS OF THE DRAWING(S)

The foregoing summary, as well as the following detailed description of preferred embodiments of the invention, will be better understood when read in conjunction with the appended drawings. It should be understood that the invention is not limited to the precise arrangements and instrumentalities shown. In the drawings:

FIG. 1 is schematic drawing of a wafer boat of the invention;

FIG. 2A is a partial perspective view of the wafer boat of FIG. 1;

FIG. 2B, including detail B, is a plan view of the wafer boat of FIG. 1; and

FIG. 2C, including detail C, is a front view of the wafer boat of FIG. 1.

### DETAILED DESCRIPTION OF THE INVENTION

The invention includes chimerized wafer boats for housing a semiconductor or solar wafer. By ‘chimerized,’ it is meant that the wafer boat is fabricated from at least two materials. The chimerized water boats of the invention satisfy the above-mentioned needs by combining the characteristics of low cost-per-unit, durability and recyclability over time. The wafer boats of the exhibit chip resistance (particularly in the region of the slots into which the wafers are placed), chemical resistance to reagents used in processing and cleaning, all at a reduced cost-per-unit. In addition, the chimerized wafer boat of the invention is able to withstand repeated handling at high temperatures and under extreme temperature fluctuations.

Also included in the invention are methods of housing semiconductor solar wafers and methods of manufacturing wafer boats that exhibit increased durability and/or chip resistance.

The wafer boat includes at least one wafer support member. The wafer support member bears the greatest mechanical load relative to the remainder of the boat's elements, when the boat in loaded with wafer(s); for example, in a horizontal wafer boat, the wafer support member is located at the base or bottom of the boat.

The wafer support member contains at least one slot capable of receiving at least a portion of a peripheral edge of the wafer. It many be preferred that more that one slot is present. The wafer support member is made wholly or in part of silicon carbide. In a preferred embodiment, the whole wafer support member is made of silicon carbide.

The wafer boat also includes at least one structural member that supports the wafer support member when the boat is moved through processing steps. The at least one structural member is comprised of a ceramic material that is not silicon carbide. Any other suitable material may be used. Preferred are ceramic materials include quartz.

The wafer support member and the at least one structural member are connected to one another. Such connection may be effected via any means known or to be developed in the art, including, for example, chemical bonding agents, mechanical fasteners, and/or combinations of the same.

If the chemical bonding agent is selected for attachment, several agents may include any that are capable of bonding the members together, but which do not release particulates or other impurities into the semiconductor and/or solar wafer processing manipulations. Examples of effective bonding agents for use in the invention may include inert polymers such as perfluoroelastomers.

Because of the importance of avoiding insertion of unnecessary impurities into a semiconductor process, it may be preferred that the wafer support member and the structural member are attached using a mechanical fastener, such as, for example, without limitation, a screw, a bolt, a pin, a peg, a staple, and the like. It may be preferred that the fastener is made of the ceramic material, such as quartz, silicon carbide, and/or crystallized silicon carbide.

It may be desirable that the movement of tolerances of the wafer support member and the structural member is no greater than ±0.05, alternatively no greater than ±0.03, ±0.02, ±0.01, and ±0.014.

Embodiments of the invention are described with reference to the accompanying drawings. As used herein, “right” and “left”, “upper” and “lower”, “inner” and “outer”, “top” and “bottom” and words of similar import or pertaining to direction and arrangement of elements are used for convenience in viewing the drawings and are not meant to be limiting.

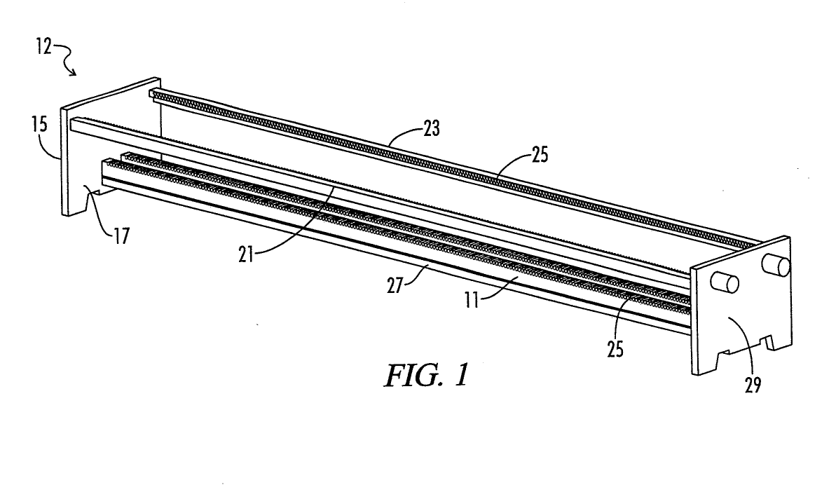

FIG. 1 shows an exemplary horizontal wafer boat (12), in which the wafer support member (11) is attached to the first side (17) of a structural member (15) that is in the form of a panel. In addition, the horizontal wafer boat (12) further includes two supplemental support rails (21, 23), each of which may bear at least one slot (25) for receipt of a peripheral edge of a semiconductor or solar wafer. The wafer support member (11) bears numerous slots (25) for receipt of the bottom peripheral edge of a wafer.

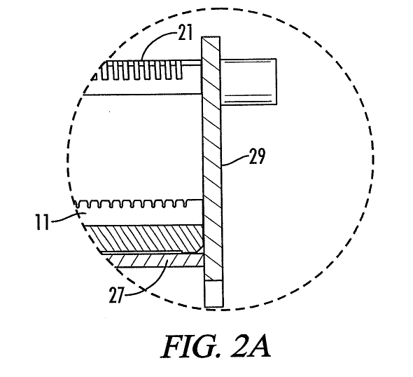

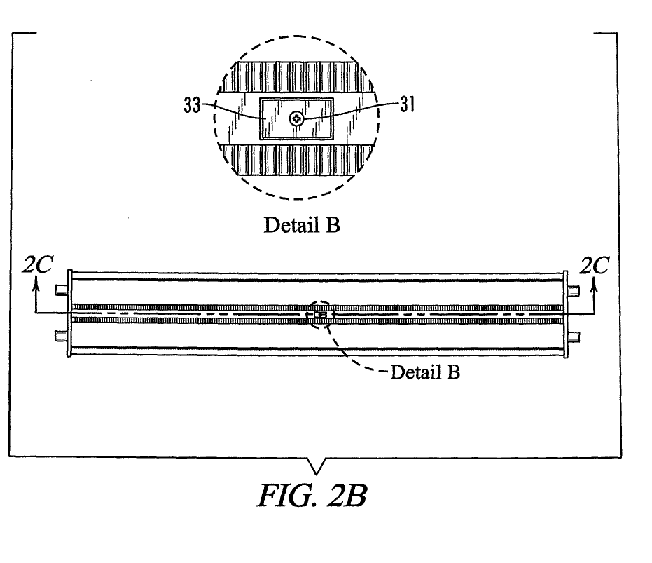

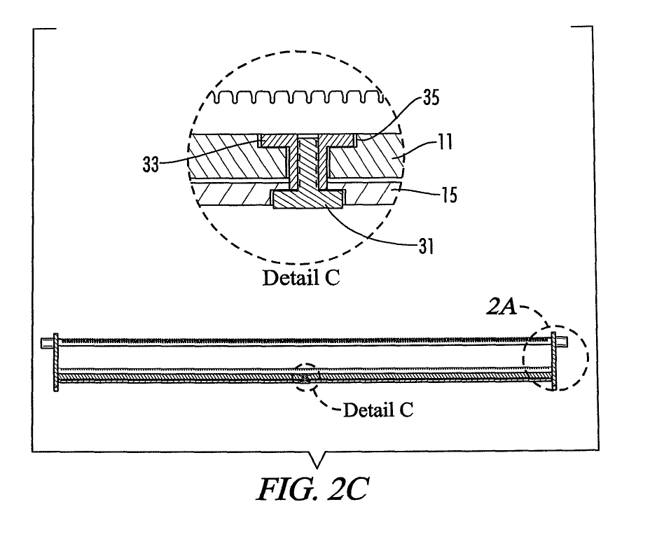

FIG. 2, which includes FIGS. 2A, 2B, and 2C, illustrates details of the wafer boat of FIG. 1. Specifically, FIG. 2A is a perspective view of the right-hand side of the wafer boat of FIG. 1. Supplemental support rail (21) bears several slots (11), each of which is capable of receiving at least a portion of the peripheral edge of a wafer.

In the embodiment shown in FIG. 2, the structural member (15) includes a side panel (29) and a lower rail (27) onto which the wafer support member is secured.

The wafer support member (11) is made of silicon carbide; the remainder of the support including the support rails and structural members are made of quartz.

In FIGS. 2C and 2B an exemplary means of attaching the wafer support member (11) to the structural member (15) is illustrated. Specifically, the wafer support member (11) is attached to the bottom rail (27) of the structural member (15) by a screw (31). The screw (31) is inserted into a bushing (33) which is nested with in a recess (35) on the bottom surface of the silicon carbide wafer support member (11).

As noted previously, the chimerized wafer boats of the invention may include any wafer boat structure or format that is known or to be developed in the art including both vertical and horizontal wafer boats. Exemplary wafer boat structures which can be used include those described in at least U.S. Pat. No. 7,501,370 (vertical wafer boat, shown at least in FIGS. 1-9); U.S. Pat. No. 6,099,302 (vertical wafer boat, shown at least in FIGS. 1-16); U.S. Pat. No. 5,054,418 (vertical wafer boat, shown at least in FIGS. 1-8); U.S. Pat. No. 7,033,168 (vertical wafer boat, shown at least in FIGS. 1-12); U.S. Pat. No. 4,566,839 (horizontal wafer boat shown at least in FIGS. 1-16); U.S. Pat. No. 5,538,230 (horizontal wafer boat, shown at least in FIGS. 1-8); D580,894; D570,309; D507,308; D551,634; U.S. Pat. Nos. 6,352,399; 6,537,010, the contents of each of which are incorporated herein by reference.

Also included within the scope of the invention are methods of housing a semiconductor or a solar wafer that includes placing the wafer in the wafer boat constructed in accordance with the structures and materials described above.

Methods of manufacturing wafer boats having increased durability and/or chip resistance are also included. Particularly preferred are wafer boats which exhibit increased chip resistance particularly within the slot region and the ability to withstand high temperatures, including up to about 800° C.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A wafer boat for housing a semiconductor or a solar wafer comprising
at least one wafer support member containing at least one slot capable of receiving at least a portion of a peripheral edge of a wafer, wherein in the wafer support member comprises silicon carbide; and
at least one structural member for conveying the wafer boat into and out of a processing device connected to the wafer support member , wherein the structural member is comprised of a ceramic material that is not silicon carbide.

2. The boat according to claim 1, wherein the structural member consists essentially of a ceramic material that is not silicon dioxide.

3. The boat according to claim 1, wherein the wafer support member consists essentially of silicon dioxide.

4. The boat according to claim 1, wherein the ceramic material is quartz.

5. The boat according to claim 1, wherein the wafer support member comprises crystallized silicon carbide.

6. The boat according to claim 1, wherein the wafer support member and the structural member are attached by a chemical bonding agent.

7. The boat according to claim 1, wherein the wafer support member and the structural member are attached by a mechanical fastener.

8. The boat according to claim 7, wherein the fastener is a chosen from a screw, a bolt, a pin, a peg, and a staple.

9. The boat according to claim 7, wherein the fastener is made of a ceramic material.

10. The boat according to claim 7, wherein the fastener is made of a ceramic material chosen from quartz, silicon carbide, and crystallized silicon carbide.

11. The boat according to claim 1, wherein the structural member is a panel having a first side and a second side, and the panel is attached to the support member such that the first side defines a plane that is parallel to the at least one slot of the wafer support member.

12. The wafer boat of claim 1, wherein the movement of tolerances of the wafer support member relative to the structural member is no greater than ±0.05.

13. The wafer boat of claim 12, wherein the movement of tolerances of the wafer support member relative to the structural member is no greater than ±0.03.

14. A method of housing a semiconductor or solar wafer comprising placing the wafer in the wafer boat of claim 1.

15. The method of claim 14, wherein the structural member consists essentially of a ceramic material that is not silicon dioxide.

16. The method of claim 14, wherein the wafer support member consists essentially of silicon dioxide.

17. The method of claim 14, wherein the ceramic material is quartz.

18. The method of claim 14, wherein the wafer support member comprises crystallized silicon carbide.

19. The method of claim 14, wherein the structural member is a panel having a first side and a second side, and the panel is attached to the support member such that the first side defines a plane that is parallel to the at least one slot of the wafer support member.

20. A method of manufacturing a wafer boat having increased durability and/or chip resistance comprising connecting at least one wafer support member containing at least one slot capable of receiving at least a portion of a peripheral edge of a wafer to at least one structural member for conveying the wafer boat into and out of a processing device, wherein the structural member is comprised of a ceramic material that is not silicon carbide and the wafer support member comprises silicon carbide
